(19) United States
(12) Patent Application Publication
(10) Pub. No.: US 2024/0210182 A1
(43) Pub. Date: Jun. 27, 2024

(54) INFORMATION PROCESSING DEVICE AND INFORMATION PROCESSING METHOD

(71) Applicant: Nissan Motor Co., Ltd., Kanagawa (JP)

(72) Inventors: Takehiro Miyoshi, Kanagawa (JP); Kotaro Chiba, Kanagawa (JP); Xiaoxiao Fei, Kanagawa (JP)

(73) Assignee: Nissan Motor Co., Ltd., Kanagawa (JP)

(21) Appl. No.: 18/556,951

(22) PCT Filed: Apr. 28, 2021
(86) PCT No.: PCT/JP2021/017048

§ 371 Date: Oct. 24, 2023

(51) Int. Cl. G01C 21/34

(52) U.S. Cl. CPC G01C 21/343; G01C 21/3476

(57) ABSTRACT

An information processing device includes a movement plan generation unit, a provider specification unit, and a transmission unit. The movement plan generation unit is configured to generate movement plan data indicating a user's movement plan. The provider specification unit is configured to extract an experience different from an original experience at a user's place that is allowed to be experienced during stay time, when the stay time at the user's place of stay included in the movement plan is equal to or longer than a predetermined time, and specify an experience provider capable of moving to the user's place of stay and providing the user with the experience. The transmission unit is configured to transmit, to the user, experience information data including information on the experience that the experience provider can provide. The movement plan generation unit is configured to calculate the stay time when the stay time becomes longer due to the user having a different experience. The transmission unit is configured to transmit, to the user, data of a movement plan including information of the calculated stay time.

### TECHNICAL FIELD

The present invention relates to an information processing device and an information processing method.

### BACKGROUND ART

Information processing devices for providing movement plans including information about available stopover locations for vehicles are known. For example, the information processing device described in Patent Literature 1 receives, from a vehicle, a route search request including search conditions such as destination set by a user, destination arrival time, and movement purpose, and searches for a movement route to the destination corresponding to the destination arrival time based on the route search request, while considering stopover location candidates according to the movement purpose, and then transmits search results to the vehicle. The vehicle presents the searched movement route to the user. Further, in response to a user's selection of a stopover location, the movement route, estimated destination arrival time, and the stopover location candidates are dynamically changed.

### CITATION LIST

### Patent Literature

Patent Literature 1: WO2017/179285

### SUMMARY OF INVENTION

### Technical Problem

However, the above-described information processing device is for searching for the movement route to the destination including stopover location candidates, and a user moving along the movement route receives experiences at a plurality of places, according to each place. Therefore, there is a problem that in order to have multiple experiences it is necessary to move to each experience place.

The problem to be solved by the present invention is to realize information processing that makes it possible to provide multiple experiences at a user's place of stay.

### Solution to Problem

The present invention solves the above problem by generating movement plan data indicating a user's movement plan, extracting an experience that is allowed to be experienced during the stay time when the stay time at a user's place of stay included in the movement plan is equal to or longer than a predetermined time, specifying an experience provider that can move to the user's place of stay and provide the user with the experience, and transmitting, to the user, experience information data including information on the experience that the experience provider can provide.

### Advantageous Effects of Invention

According to the present invention, it is possible to provide a user with multiple experiences at the user's place of stay.

### BRIEF DESCRIPTION OF DRAWINGS

FIG. 1 is a block diagram illustrating an embodiment of an information processing system according to the present invention.

FIG. 2 is a diagram illustrating an example of a user table stored in a database of FIG. 1.

FIG. 3 is a diagram illustrating an example of a table of provider data stored in the database illustrated in FIG. 1.

FIG. 4 is a flowchart illustrating an information processing procedure that can be executed by the information processing system illustrated in FIG. 1.

FIGS. 5A and 5B are diagrams illustrating display screens displayed on a display of a terminal device of FIG. 1.

### DESCRIPTION OF EMBODIMENTS

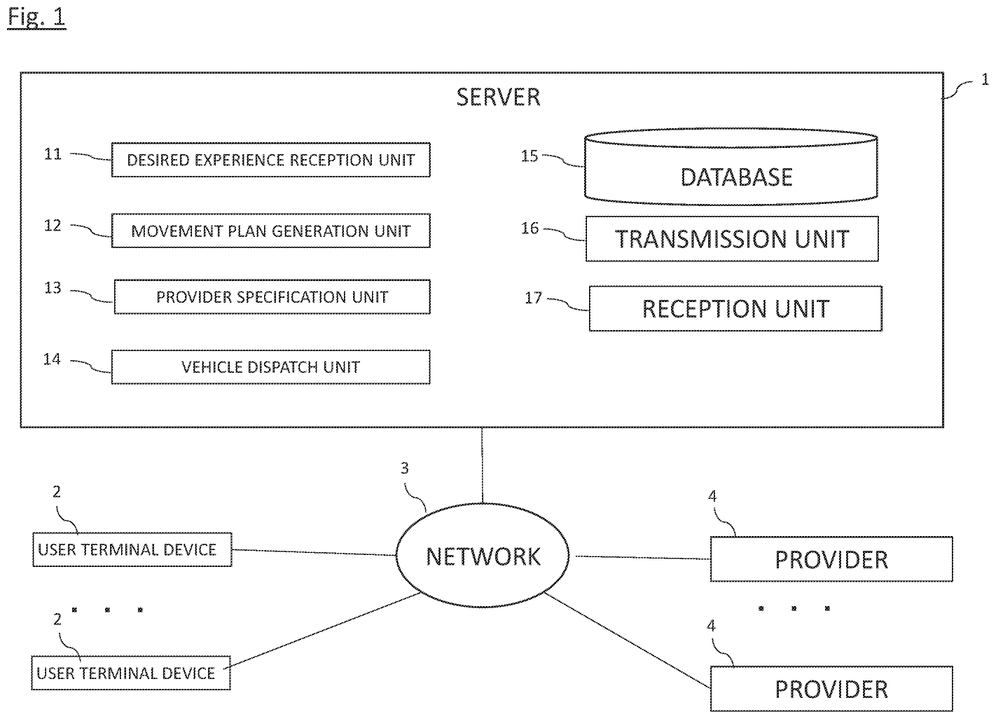

Hereinafter, an embodiment of an information processing system according to the present invention will be described with reference to the attached drawings. FIG. 1 is a block diagram illustrating an information processing system according to an embodiment of the present invention. The system of the present embodiment includes a server 1, a plurality of user's terminal devices 2, a network 3 configuring a telecommunications network, and one or a plurality of providers 4. The system of the present embodiment specifies an experience provider capable of moving from a place other than a user's place of stay to the user's place of stay for provision of experience to the user, and provides the user with not only an original experience at the user's place of stay but also an experience different from the original experience at the user's place of stay. The user's place of stay is not limited to user's final destination, and may be each destination (transit point on a movement route) when the user moves to the final destination via each destination. In other words, the user's place of stay is a place where the user stays for a predetermined time or more. Further, the information processing system notifies experience providers that there is an opportunity to provide experiences to users visiting their places of stay. In the following description, the user's place of stay including the final destination and/or transit points will be collectively referred to as “destination”.

Although not particularly limited, in order to facilitate understanding of the present invention, an example is given as follows. When a user wants to have a specific experience such as eating pasta, bathing in a hot spring, or buying a book, it is conventionally general that the user uses a terminal device such as a smartphone to search for a facility or store capable of providing the experience, and then the user visits the searched facility and store capable of providing the experience, respectively, for the experience. Further, in the case of searching for stores using a conventional gourmet website, even if places and store names are displayed, stores cannot provide users with experiences such as products or services unless the users visit the stores. Therefore, the system of the present embodiment specifies, as destinations, places capable of providing experiences that users desire, and specifies providers so that multiple experiences can be provided at the destinations. This enables users to have not only original experiences at their destinations but also experiences different from the original experiences at the destinations. That is, users can have multiple experiences at their destinations. Further, providers can have opportunities to provide experiences to users visiting destinations.

The “desired experience” according to the present embodiment means a matter that each user wants to experience, and is an experience of “desiring to eat”, especially “desiring to eat pasta” or “desiring to eat ice cream”, in the above-described example. In addition to this type of experience of desiring to eat, there are other genres of services such as desiring to shop, desiring to visit a park, and desiring to bathe in a hot spring. The system of the present embodiment includes such a variety of experiences. In other words, the experiences desired by users include purchase of products by the users and/or services experienced by the users.

The server 1 of the present embodiment is configured by a computer including hardware and software, and includes a ROM storing programs, a CPU executing the programs stored in the ROM, and a RAM that functions as an accessible storage device. As an operating circuit, the CPU may be replaced by or used together with MPU, DSP, ASIC, FPGA, or the like. Further, as illustrated in FIG. 1, a desired experience reception unit 11, a movement plan generation unit 12, a provider specification unit 13, and a vehicle dispatch unit 14 realize each function described below by the software established in the ROM. Further, the server 1 includes a database 15 as a storage unit. While using information stored in the database 15, the desired experience reception unit 11, the movement plan generation unit 12, the provider specification unit 13, and the vehicle dispatch unit 14 described above realize each function described below. Further, the server 1 includes a transmission unit 16 and a reception unit 17 configured to transmit and receive data including information processed by various functions and the information stored in the database 15 to and from the terminal devices 2 and the provider 4.

As a premise of the system of the present embodiment, multiple persons who can be users own their terminal devices 2 that are carried or used on a daily basis. Smartphones, mobile telephones, and portable computers can be used as this kind of terminal devices 2. The terminal device 2 of the present embodiment has computer functions, and includes an input unit for inputting data, a communication function for transmitting the input data to the server 1, a location detection function such as a GPS receiver that detects the current location of the terminal device 2, and a display function for displaying data transmitted from the server 1 on its display. Each terminal device 2 transmits its own ID, current location, and input data to the server 1 via the Internet or another network 3 (wireless communication network).

The provider 4 provides a user with an experience at a provision place of a product and/or service specified by the server 1. The provider 4 is a store having a physical store, a business operator providing products/services with a moving vehicle without any physical store, a business operator providing only products for home delivery using only a cooking place, a business operator providing no product but setting up a facility for providing products/services at a predetermined place, or the like. The provider 4 provides products/services at a place specified by the server based on information provided by the server 1.

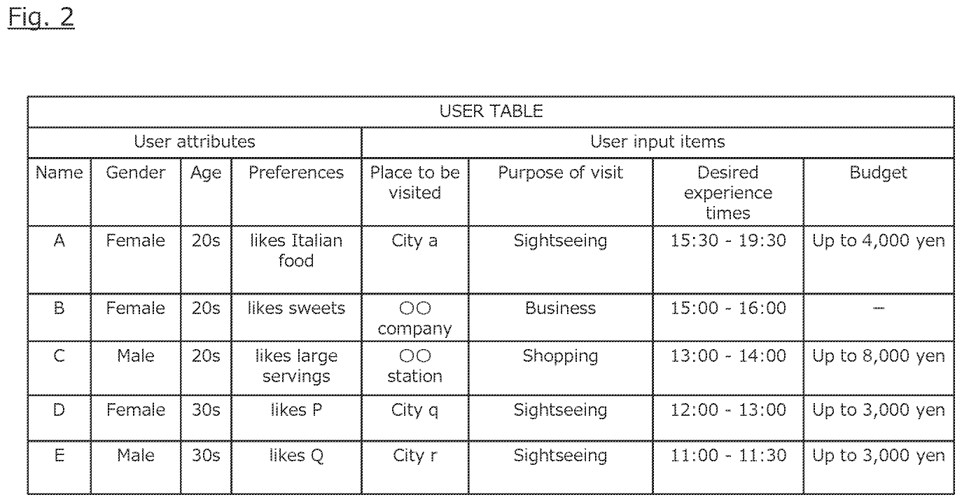

Next, the configuration of the server 1 will be described. The desired experience reception unit 11 receives, via the network 3, information transmitted from the terminal devices 2 carried by multiple users. FIG. 2 illustrates experience desire data acquired by the desired experience reception unit 11. The experience desire data includes information about the experience desired by users, and is categorized into user attribute and user input items. The user attributes are determined by information entered by users at the time of initial registration for using services in this system. As illustrated in FIG. 2, the user attributes include personal information such as name, gender, and age, and preferences indicating user preferences. For example, User A is “female” in gender, “twenties” in age, and “likes Italian food” in preferences.

When using the services in this system, users input destination information required for specifying the destination. The destination information to be input may be any information that can specify the destination, and is not limited to locational information of the destination, and may be vague information such as areas to be visited and purposes of visit. Further, experience desire information may be input as the destination information. For example, if the desired experience relates to eating and drinking, the experience desire information to be input may be food name such as “pasta” or “ice cream”, or genre of food such as “Chinese food” or “Japanese food”. That is, the experience information to be input is not limited to specific names such as product names and service names, and may be vague information. In the example of FIG. 2, information on “place to be visited” and “purpose of visit” is input as the experience desire information. Further, user's input items include, as information relating to the desired experience, desired experience time zone, budget, and the like. Further, the experience desire data also includes user's locational information. The user's location corresponds to locational information that can be detected by the location detection function such as the GPS receiver of the terminal devices 2.

The desired experience time represents the time to experience the service of this system, and corresponds to the total time of the movement time in the movement plan and the stay time at the destination. For example, in the example of FIG. 2, it is expressed that, between 15:30 and 19:30, User A wants to move from the current location to the destination for experience, have the desired experience at the destination, and then move to a spot designated by the user. The budget is the expense for having the experience.

The desired experience reception unit 11 acquires the experience desire data from the terminal devices 2 via the network 3, and causes the database 15 to store the acquired experience desire data. The database 15 stores the experience desire data of each user, as a table as illustrated in FIG. 2.

The movement plan generation unit 12 specifies a destination where the experience can be provided based on map data and the experience desire data, and generates a movement plan for moving to the destination. The movement plan includes a movement route for moving from the user's current location to the destination and moving to the location designated by the user and the experience time. Further, the movement plan includes information such as fees required to move, and the expense to be consumed at the destination. The movement route information is not always required to be represented by a route on a map, and may include minimum information such as train boarding and alighting stations required for the user to move. Further, the movement plan includes a traveling route by vehicle, a movement route using a train, a walking route, or the like. Further, when there are multiple destinations, the movement route is a route for moving through each destination to the place designated by the user.

When the destination information input by the user is specific locational information, the movement plan generation unit 12 calculates a route for moving to the spot indicated by the locational information. On the other hand, when the destination information input by the user is experience information desired by the user, a place where the experience desired by the user can be provided is proposed to the user as the destination. A method for specifying the destination from the experience desire information will be described with reference to FIG. 2. In the example of FIG. 2, User A has entered “City a” as the place to be visited and “sightseeing” as the purpose of visit. The movement plan generation unit 12 specifies a spot suitable for the “sightseeing” within the area of “City a”. The movement plan generation unit 12 calculates a route moving from the user's current location to the place designated by the user via the proposed sightseeing spot. When specifying the sightseeing spot and calculating the route, the movement plan generation unit 12 generates a movement plan so that the stay time at the sightseeing spot and the movement time are within the desired experience time designated by User A. The stay time may be specified by arithmetic processing by the movement plan generation unit 12, or may be specified from the experience desire data entered by the user. The movement plan generation unit 12 proposes the movement plan to User A by transmitting data of the generated movement plan to User A. When User A approves the proposal from the server 1, the movement plan is finalized.

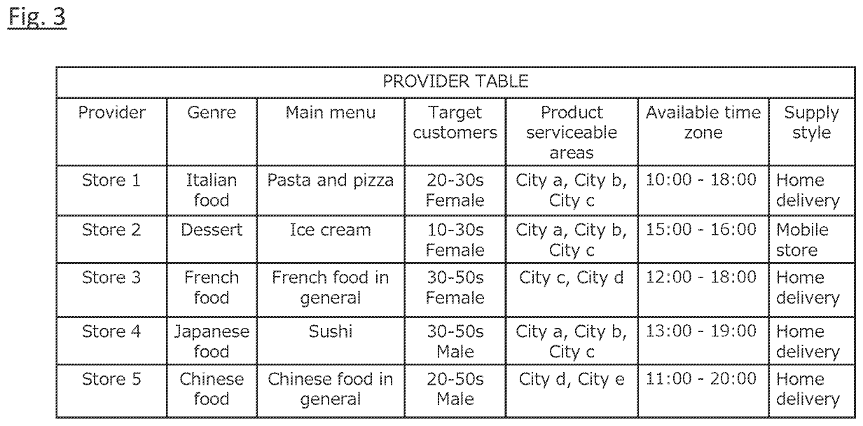

The provider specification unit 13 refers to the data stored in the database 15, and specifies a provider that provides the user with the experience. The database 15 stores store or facility information as provider data so that services in this system are available. FIG. 3 is a table of the provider data stored in the database 15. The provider data includes information about the content of providable experiences and places where the experiences can be provided. The provider data is determined by the information entered by users at the time of initial registration for using services in this system. The users are mainly business operators that can provide the experiences. As illustrated in FIG. 3, the provider data includes information such as provider's store name, genre, main menu, target customers, price range, product serviceable area, available time zone, and supply style. For example, the store named “Store 1” provides Italian products, with pasta and pizza as main menu. The main target customers visiting “Store 1” is in their twenties and thirties. The price range corresponding to the average unit price per customer is 1000 to 2000 yen. These kinds of information may be input by business operators at the time of initial registration, or may be extracted from store's performance data, word-of-mouth communication information on gourmet websites, etc. and stored in the database 15.

In the example of FIG. 3, the provider of “Store 1” can provide products at areas of City a, City b, and City c. The product serviceable areas are determined by the input at the time of initial registration. Alternatively, areas located in a predetermined range from the location of Store 1 may be regarded as the product serviceable areas. The supply style is a style for providing products or services to be experienced. For example, in the example of FIG. 2, the supply style of “Store 1” is “home delivery”, and is a style using the home delivery service to deliver the product made at the store to the destination. Further, in the example of FIG. 2, the supply style of “Store 2” is “mobile store”, according to which a vehicle mounting the entire store or a part of store's functions moves to the destination and the vehicle is used as the store that provides products.

The provider specification unit 13 specifies an experience provider that can provide experiences at the destination determined from the movement route. Further, the provider specification unit 13 specifies, from the experience desire data acquired by the desired experience reception unit 11, user's preferences, desired experience time, and budget, and specifies the experience provider from the specified information. The experience provider moves from a place different from the destination to the destination, and provides experiences different from original experiences at the destination. For example, if the destination is a park, the provider specified by the provider specification unit 13 is not a restaurant located within the park ground but is the business operator that can move to the park and provide products/services. The moving from the place different from the destination includes moving for transporting products provided at the store by the home delivery in the case of a store having a physical store, moving of products/services with a moving vehicle without using any physical store, and moving of products/services by the home delivery. The desired experience time corresponds to the user's stay time at the destination.

When User A shown in FIG. 2 applies to this system and expresses user's desire to experience, the movement plan generation unit 12 specifies a destination where the experience can be provided based on map information and the experience desire information, and generates a movement route. The provider specification unit 13 specifies a provider that can provide the experience at the destination determined by the movement route. For example, in the case of application from User A, a provider within “City a” being the place to be visited is specified. The provider specification unit 13 extracts information about User A's preferences from the user table stored in the database 15. Since User A “likes Italian food” in preferences, the provider specification unit 13 determines an experience of “eating Italian food” as an experience to be proposed to User A, and specifies a provider that can provide this experience. In the example of FIG. 3, since “City a” is included in the “product serviceable area” of Store 1, the product can be provided and “pasta” can be provided if it is a destination (sightseeing spot) within “City a”. Therefore, Store 1 is specified as an experience provider to be proposed to User A. Further, the provider specification unit 13 specifies a provider that can provide an experience suitable after eating “pasta” from the stay time of User A at the destination. For example, experiences suitable after eating “pasta” include “dessert” and “massage”. In the example of FIG. 2, “City a” is included in the “product serviceable area” of Store 2, and “ice cream” can be provided as dessert. Therefore, Store 2 is specified as an experience provider to be proposed to User A. In this manner, the provider specification unit 13 specifies a provider that can provide another experience accompanying a certain experience. That is, the provider specification unit 13 extracts an experience that can be experienced during the stay time of User A, and specifies an experience provider that can provide the extracted experience. In above-described example, “pasta” and “ice cream” are extracted as experiences that can be experienced during the stay time of User A. Store 1 that provides “pasta” and Store 2 that provides “ice cream” are specified as experience providers.

Although a method for specifying a provider based on user's preferences has been described in the above description, it is not always required to specify the experience provider based on user's preferences. For example, if user's arrival time to the destination is 12:00 and the stay time (desired experience time) is two hours from 12:00 to 14:00, there is a higher possibility that the user will eat at or near the destination. In such a case, the provider specification unit 13 may specify, as the experience provider, a restaurant around the destination. Further, when the budget is included in user's experience desire information, the provider specification unit may specify an experience provider within the budget.

Further, the provider specification unit 13 may not provide another provider if there is any overlap in experience content with the previously specified provider. The overlap in experience content is not limited to the case where the experience content is completely matched, and may include a case where the experience content is similar, such as a case where the experience content is identical in genre. For example, in the example of FIG. 2, when Store 1 is specified as the experience provider, the provider specification unit 13 does not specify another provider that provides products for lunch as the experience provider. After eating “pasta”, the user is unlikely to eat another product for lunch (e.g., hamburger). Therefore, if there is any overlap in experience content, the provider specification unit 13 suspends specifying the experience provider.

Further, the provider specification unit 13 may refer to the usage history of other users when specifying the experience provider. When the user uses the product and/or service of the provider proposed by the server 1, the server 1 stores the usage history in the database 15 in association with the destination. The provider specification unit 13 refers to the usage history stored in the database 15 and specifies, as the experience provider, a provider that has been used in the past at the destination included in the movement plan.

Further, the provider specification unit 13 may determine the experience to be proposed to the user according to the length of stay time at the destination. For example, in the case of providing an experience of eating and drinking, if the stay time is longer, the provider specification unit 13 determines an experience such as pasta or steak, which will make an enjoyable meal time, as a proposed experience. On the other hand, if the stay time is shorter, the provider specification unit 13 determines an experience such as hamburger or ice cream, which can be eaten within a short time, as a proposed experience.

Further, the provider specification unit 13 may determine the experience to be proposed to the user according to the status of facilities at the destination. The status of facilities at the destination includes the presence of seats, roofs, and garbage dumps. For example, in the case of providing the experience of eating and drinking, if there is any available seat at the destination, the provider specification unit 13 determines an experience of sitting down and eating as a proposed experience.

Further, the provider specification unit 13 may determine the experience to be proposed to the user according to attributes of the destination. The attributes of the destination are categorized according to the purpose of stay, such as sightseeing, business, and rest. For example, in the case that the destination's attribute is sightseeing, an experience of “buying a souvenir” is provided. In the case that the destination's attribute is business, the provider specification unit 13 determines, as a proposed experience, an experience of eating foods and drinking beverages with little odor among foods and beverages. Then, the provider specification unit 13 specifies a provider that can provide the experience determined in the manner described above, as an experience provider.

When the experience provider is specified by the provider specification unit 13, information about the experience to be provided by the experience provider is included in experience information data and transmitted to the user or the provider. The experience information relating to the experience is information about the experience at the destination such as store names of experience providers, names of products/services provided, and genres of products/services. Further, the experience information may include advertisement information of the experience provider.

The vehicle dispatch unit 14 dispatches vehicles moving to destinations to providers and/or users. When the supply style of a provider specified by the provider specification unit 13 is home delivery, it is necessary to transport products or the like from stores to destinations. In such a case, the vehicle dispatch unit 14 arranges vehicles for home delivery in accordance with the user's arrival at the destinations. The vehicle dispatch unit 14 transmits vehicle dispatch information to the provider 4. Further, when a user moves to a destination using a vehicle that is not owned by the user, such as a taxi or a rental car, the vehicle dispatch unit 14 dispatches a vehicle moving to the destination to the user.

The vehicle dispatch unit 14 may transmit location data indicating the user's current location to a vehicle to be dispatched. From the location data, the dispatched vehicle can confirm user's arrival time at a user's destination, which is the place of arrival for the dispatched vehicle. This enables the dispatched vehicle to deliver the product or the like relating to the experience in time with the user's arrival at the destination.

The database 15 stores, as a table, user's experience desire data and provider data. The database 15 also stores the map information and the like. The provider table in the database 15 stores at least provider's identification information and product serviceable areas while associating them with each other. The provider's identification information is indicated by the store name, ID, or the like, as illustrated in FIG. 3. Further, the database 15 also stores usage history of users and providers.

The transmission unit 16 is connected, via the network 3, to the user terminal devices 2 and the terminals of the providers 4. The transmission unit 16 transmits a notification signal relating to the experience to the providers. The notification signal is a signal for notifying that the user will visit the destination indicated by the movement plan. By receiving this notification signal, the providers can confirm that there is a business opportunity at the user's destination. Further, the transmission unit 16 transmits data including the movement plan and information on the provider capable of providing the experience at the destination, to the user's terminal devices 2. Since the experience content and destination specified by the server may not match user's desire, information on the experience content and destination is sent to the user in advance.

The reception unit 17 is connected, via the network 3, to the user terminal devices 2 and the terminals of the providers 4. The reception unit 17 receives data transmitted from the terminal devices 2 and data transmitted by the terminals of the providers 4.

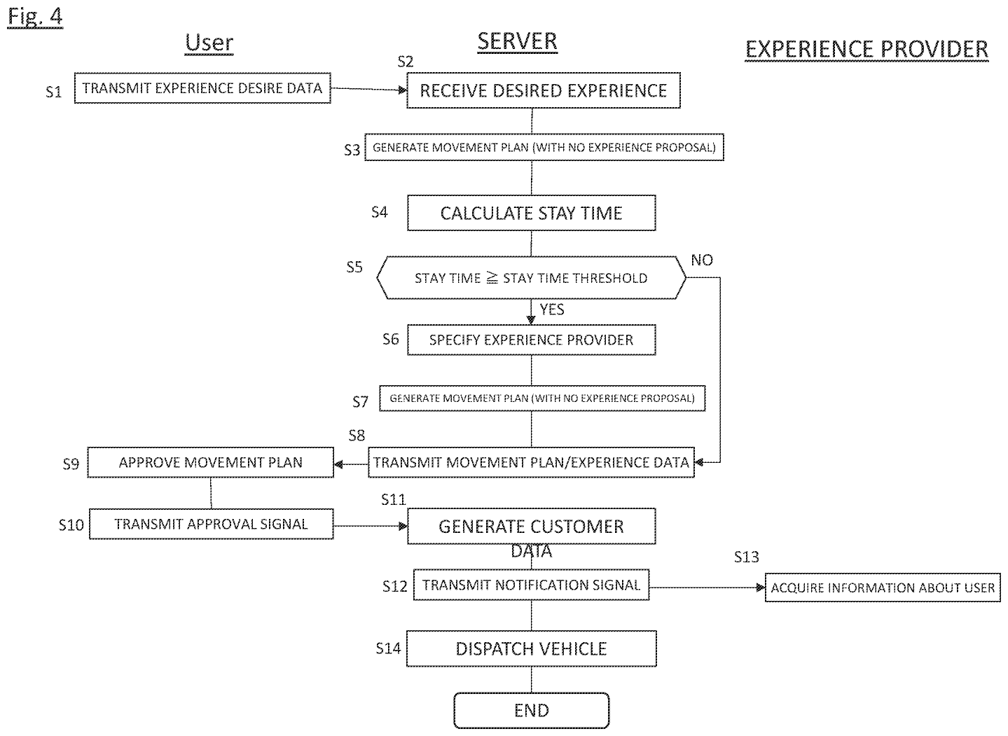

Next, an outline of an information processing procedure that can be executed by the system of the present embodiment will be described. FIG. 4 is a flowchart illustrating this information processing procedure.

First, in step S1, when a user accesses the server 1 using the terminal device 2, the user's terminal device 2 displays a screen where places to be visited, purposes of visit, desired experience time zones, budgets, and the like can be entered, as information about the above-described desired experience. The user enters information for each item. Further, a location detection sensor such as a GPS receiver provided in the terminal device 2 detects the latitude and longitude. This locational information is transmitted to the server 1 together with the information about the desired experience.

In step S2, the desired experience reception unit 11 of the server 1 receives, via the network 3, the above-described information transmitted from the terminal devices 2 carried by respective users, at predetermined time intervals (e.g., 100 msec). The experience desire data transmitted from the terminal device 2 includes information about the desired experience, as illustrated in FIG. 2, in addition to the ID of the user owning the terminal device 2. The desired experience reception unit 11 stores the acquired experience desire data in the database 15.

In step S3, the movement plan generation unit 12 of the server 1 generates a movement plan. The movement plan generated in the control processing of step S3 does not include information about an experience provider specified by the provider specification unit 13. The movement plan generation unit 12 temporarily generates the movement plan in the absence of an experience proposal in order to calculate the stay time at the destination designated by the user.

In step S4, the movement plan generation unit 12 calculates the stay time at the destination in the movement plan. For example, if the destination is a sightseeing spot, the stay time is calculated using the time determined from a standard sightseeing model. The time data used to calculate the stay time is stored in the database in association with facilities or the like that can be destinations. That is, the movement plan generation unit 12 refers to the data stored in the database and calculates the stay time for each destination determined in the movement plan. When user's departure time and arrival time are determined in advance, the movement plan generation unit 12 may obtain remaining time by subtracting the movement time from the total time, i.e., time between the departure time and the arrival time, appropriately apportion the obtained remaining time for each destination determined in the movement plan, and calculate the apportioned time as the stay time for each destination.

In step S5, the movement plan generation unit 12 compares the calculated stay time with a stay time threshold. The stay time threshold indicates an upper limit of time for proposing to the user an experience different from the original experience at the destination. When the user has an experience different from the original experience at the destination, there is a possibility that the stay time may become longer. Therefore, if a longer stay time is securable, another experience is proposed. The stay time threshold may be differentiated for each destination.

When the stay time is less than the stay time threshold, the server 1 executes control processing in step S8 described below. If the stay time is equal to or greater than the stay time threshold, then in step S6, the provider specification unit 13 refers to the provider data stored in the database, extracts an experience that can be experienced during the stay time, and specifies an experience provider capable of providing the experience at the destination.

In step S7, the movement plan generation unit 12 generates a movement plan including information on the experience that can be provided by the experience provider. Further, if the stay time is likely to become longer when the user has the proposed experience, the movement plan generation unit 12 calculates the stay time and reflects information about the calculated stay time on the movement plan.

In step S8, the transmission unit 16 transmits, to the user's terminal device 2, movement plan data and/or experience information data including experience information. When the control processing of steps S6 and S7 has not been executed, the control signal transmitted from the transmission unit 16 to the terminal device 2 does not include the experience information data.

When the control signal to be transmitted from the transmission unit 16 to the terminal device 2 is transmitted, the terminal device 2 displays the movement plan data included in the control signal on a display of the terminal device 2. Further, when the control signal includes the experience information data, the terminal device 2 displays the experience information added to the movement plan on the display of the terminal device 2. Further, when the control signal requests the user to decide whether to approve or deny the experience or the movement plan extracted by the provider specification unit 13, the terminal device 2 displays a screen for approval or denial selection on the display. That is, the control signal is also a command signal for displaying the movement plan on the display of the terminal device 2.

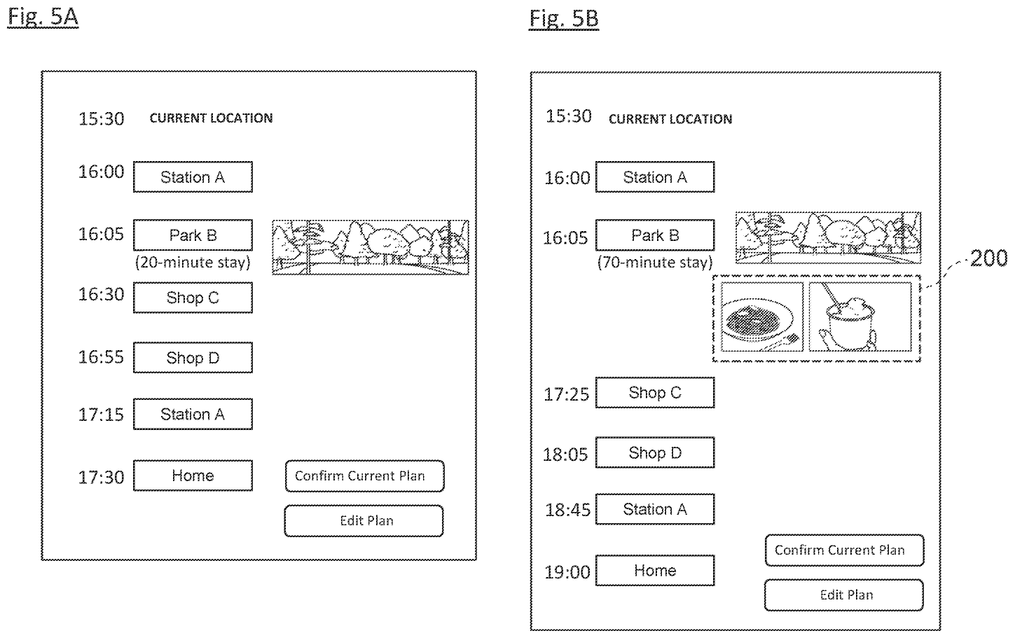

Here, a display screen of the display to be displayed when the experience information data is included and a display screen of the display to be displayed when the experience information data is not included will be described with reference to FIGS. 5A and 5B. FIGS. 5A and 5B illustrate screens to be displayed on the display of the terminal device 2. FIG. 5A illustrates the display screen to be displayed when the experience information data is not included and FIG. 5B illustrates the display screen to be displayed when the experience information data is included. The display screens of FIGS. 5A and 5B represent screens to be displayed on the display of the terminal device 2 owned by User A of FIG. 2. For the place to be visited and the purpose of visit designated by User A, the provider specification unit 13 specifies “park B”, “store C”, and “store D” as destinations for sightseeing. User A's departure time, arrival time, main stopover points other than sightseeing destinations, and stay time are shown in FIG. 5. Further, in the display screens of FIGS. 5A and 5B, icons of vehicles and persons represent means of transportation. In the display screens of FIGS. 5A and 5B, a button display of “Go with this” is displayed to enable the user to select whether to approve or deny the movement plan and/or the proposed experience. Further, when the user wants to change the movement plan and/or the proposed experience, the user may select a button display of “Edit the plan” on the display screens of FIGS. 5A and 5B.

In the example of FIG. 5A, the time from the departure time to the arrival time is 2 hours, and the stay time at the destination “park B” is 20 minutes, which is shorter. In such a case, no experience information is displayed. On the other hand, in the example of FIG. 5B, the time from the departure time to the arrival time is 3 hours and 30 minutes, and the stay time at the destination “park B” is 70 minutes, which is longer. In such a case, the experience provider is specified by the provider specification unit 13 and the experience information is displayed on the display of the terminal device 2. In FIG. 5B, an image 200 represents the experience information. By confirming the display screen of FIG. 5B, User A can confirm that she can experience “eating pasta” and/or “eating ice cream” while enjoying the park being the purpose of sightseeing.

In step S9, the user approves the movement plan and/or the proposed experience by selecting the button display of “Go with this” in the screen displayed on the display of the terminal device 2. In step S10, the terminal device 2 transmits an approval signal to the server 1.

In step S11, the provider specification unit 13 generates customer data after receiving the approval signal. The customer data includes information on users who visit the destination. In the example of FIGS. 5A and 5B, the customer data includes information about User A. The customer data includes information such as the destination, age group of users, time of stay of users, user's preferences, desired product, and user's budgets.

In step S12, the transmission unit 16 transmits a notification signal to the terminal of the provider 4. The notification signal includes the customer data. In step S13, the provider 4 acquires information about the user arriving at the destination by receiving the notification signal. In the example of FIGS. 5A and 5B, the provider can acquire information indicating that the user will arrive at the destination “park B” and information about User A's attributes. Since the provider 4 can confirm user's preferences or the like from the user attributes included in the notification signal, it is possible to prepare products suitable for the user.

In step S14, the vehicle dispatch unit 14 dispatches a vehicle arriving at the destination to the provider and/or the user. Then, the server 1 terminates the flow of the control processing illustrated in FIG. 4.

As described above, according to the information processing system of the present embodiment, the server 1 includes: the movement plan generation unit 12 configured to generate movement plan data indicating a user's movement plan; the provider specification unit 13 configured to extract an experience that can be experienced during stay time, when the stay time is equal to or longer than the predetermined time, and specify an experience provider capable of moving to the destination (user's place of stay) and providing the user with the experience; and the transmission unit 16 configured to transmit, to the user, experience information data including information on the experience that the experience provider can provide. This makes it possible to provide the user with multiple experiences at the destination. That is, it is possible to provide the user with not only an original experience at the destination but also an experience different from the original experience at the destination.

Further, according to the information processing system of the present embodiment, the vehicle dispatch unit 14 includes the vehicle dispatch unit, which is configured to dispatch a vehicle that moves to the destination (user's place of stay) for the experience provider and/or the user. This makes it possible to use services of this system even in the business style with no store. Further, users can move to the destination by vehicle.

Further, according to the information processing system of the present embodiment, the server 1 includes the reception unit 17 configured to receive location data indicating the user's current location. The transmission unit 16 transmits user's location data to the vehicle. This makes it possible to confirm user's arrival time at the place where the dispatched vehicle arrives, from the user's location data. The dispatched vehicle can travel in time with the user's arrival at the destination.

Further, according to the information processing system of the present embodiment, the transmission unit 16 transmits the control signal that causes the user's terminal device 2 to display the experience information data. This enables users to confirm the information on experiences proposed by the server.

Further, according to the information processing system of the present embodiment, the server 1 includes the desired experience reception unit 11 configured to acquire experience desire data relating to the experience desired by the user. The movement plan generation unit 12 sets, based on the experience desire data, a place where the experience desired by the user can be provided, as the destination (user's place of stay), and the transmission unit 16 transmits data including information on the destination (user's place of stay) to the user. This enables the server 1 to propose user's destinations that match user's desired experiences.

Further, according to the information processing system of the present embodiment, the provider specification unit 13 determines an experience according to the length of stay time, and specifies a provider capable of providing the determined experience as an experience provider. This makes it possible to provide users with experiences that match the length of stay time.

Further, according to the information processing system of the present embodiment, the provider specification unit 13 determines an experience according to the facility status of the destination (user's place of stay) and specifies a provider capable of providing the determined experience as an experience provider. This makes it possible to provide users with experiences that match the facility status of the destination.

Further, according to the information processing system of the present embodiment, the provider specification unit 13 determines an experience according to attributes of the destination (user's place of stay), and specifies a provider capable of providing the determined experience as an experience provider. This makes it possible to provide users with experiences that match the attributes of the destination.

Further, according to the information processing system of the present embodiment, the transmission unit 16 transmits the experience information data including information on the experience that can be provided by the experience provider. This enables users to confirm the content that can be experienced.

Further, according to the information processing system of the present embodiment, the transmission unit 16 transmits the signal for enabling users to select approval or denial with respect to the experience extracted by the provider specification unit 13. This enables users to present, to the server, their intent to desire the experience before arriving at the destination.

Further, according to the information processing system of the present embodiment, the transmission unit 16 transmits the signal that enables users to select approval or denial with respect to the experience extracted by the provider specification unit 13. The vehicle dispatch unit 14 dispatches a vehicle that moves to the destination (user's place of stay) to users, in response to reception of a signal indicating approval of the experience. This enables users to have desired experiences after moving to the destination by vehicle.

In a system according to a modified example of the present embodiment, the provider specification unit 13 may determine, when specifying multiple experience providers, the order of providing users with the experience according to types of the multiple experience providers. In the example of FIG. 2, when Store A and Store B are specified as experience providers to be proposed to User A, the provider specification unit 13 determines an experience provision order so that “ice cream” is provided to User A next to “pasta”. That is, since “pasta” is a product for lunch and “ice cream” is a product for dessert, types of products are taken into consideration in determining the order. In another example, if “pasta” and “massage” are specified as product/service relating to the experience, the experience provision order will be determined so that “eating pasta” is followed by “having massage”.

Further, in a system according to a modified example of the present embodiment, the vehicle dispatch unit 14 may dispatch a vehicle so that the dispatched vehicle arrives at destinations in the experience provision order. This makes it possible to deliver products or the like to the destination in time with user having the experience.

Further, in a system according to a modified example of the present embodiment, the transmission unit 16 may transmit, to the user's terminal device 2, time information indicating that experiences can be provided in the order determined by the provider specification unit 13, so as to be included in the control signal for the display on the display of the user's terminal device. The user can confirm the provision order of multiple experiences from the display screen on the display of the terminal device 2.

Further, in a system according to a modified example of the present embodiment, the transmission unit 16 may transmit, to the vehicle, a control signal that causes an in-vehicle device to display the experience information data when the user is in the vehicle, and may transmit a control signal for causing a terminal device owned by the user to display the experience information data, to the terminal device 2, when the user is outside the vehicle. This makes it possible to display the experience information data so as to match a display that the user can visually recognize. The above-described desired experience reception unit 11 corresponds to the “acquisition unit” according to the present invention.

### REFERENCE SIGNS LIST

1: server
2: user terminal device (terminal device)
3: network
4: provider
11: desired experience reception unit
12: movement plan generation unit
13: provider specification unit
14: vehicle dispatch unit
15: database
16: transmission unit
17: reception unit

1. An information processing device comprising:
a movement plan generation unit configured to generate movement plan data indicating a user's movement plan;
a provider specification unit configured to extract an experience different from an original experience at a user's place when the stay time at the user's place of stay included in the movement plan is equal to or longer than a predetermined time, and specify an experience provider capable of moving to the user's place of stay and providing the user with the experience; and
a transmission unit configured to transmit, to the user, experience information data including information on the experience that the experience provider can provide,
wherein the movement plan generation unit configured to calculate the stay time when the stay time becomes longer due to the user having a different experience, and
the transmission unit configured to transmit, to the user, data of a movement plan including information of the calculated stay time.

2. The information processing device according to claim 1, further comprising;
a vehicle dispatch unit configured to dispatch a vehicle that moves to the user's place of stay for the experience provider and/or the user.

3. The information processing device according to claim 2, further comprising
a reception unit configured to receive location data indicating a current location of the user,
wherein the transmission unit transmits the location data to the vehicle.

4. An information processing device comprising:
a movement plan generation unit configured to generate movement plan data indicating a user's movement plan;
a provider specification unit configured to extract an experience that is allowed to be experienced during stay time, when the stay time at a user's place of stay included in the movement plan is equal to or longer than a predetermined time, and specify an experience provider capable of moving to the user's place of stay and providing the user with the experience; and
a transmission unit configured to transmit, to the user, experience information data including information on the experience that the experience provider can provide,
wherein the provider specification unit specifies multiple experience providers, and determines an order of providing the user with the experience according to types of the multiple experience providers, and
wherein the vehicle dispatch unit dispatches a vehicle such that the vehicle arrives at the user's place of stay in the determined order.

5. The information processing device according to claim 1, wherein
the provider specification unit specifies multiple experience providers, and determines an order of providing the user with the experience according to types of the multiple experience providers, and
the transmission unit transmits a control signal that causes a user's terminal device to display time information indicating that the experience is allowed to be provided in the determined order.

6. The information processing device according to claim 1, wherein
the transmission unit transmits a control signal that causes a user's terminal device to display the experience information data.

7. The information processing device according to claim 1, further comprising:
an acquisition unit configured to acquire experience desire data relating to an experience desired by a user,
wherein the movement plan generation unit sets, based on the experience desire data, a place where the experience desired by the user is allowed to be provided at the user's place of stay, and
the transmission unit transmits, to the user, data including information on the user's place of stay.

8. An information processing device comprising:
a movement plan generation unit configured to generate movement plan data indicating a user's movement plan;
a provider specification unit configured to extract an experience that is allowed to be experienced during stay time, when the stay time at a user's place of stay included in the movement plan is equal to or longer than a predetermined time, and specify an experience provider capable of moving to the user's place of stay and providing the user with the experience; and
a transmission unit configured to transmit, to the user, experience information data including information on the experience that the experience provider can provide,
wherein the provider specification unit specifies multiple experience providers, and determines the order of providing the user with the experience according to types of the multiple experience providers.

9. The information processing device according to claim 1, wherein
the transmission unit:
transmits a control signal that causes an in-vehicle device to display the experience information data when the user is in the vehicle to the vehicle, and
transmits a control signal that causes a terminal device owned by the user to display the experience information data to the terminal device when the user is outside the vehicle.

10. The information processing device according to claim 1, wherein
the provider specification unit determines the experience according to a length of the stay time, and specifies a provider capable of providing the determined experience as the experience provider.

11. The information processing device according to claim 1, wherein
the provider specification unit determines the experience according to a facility status of the user's place of stay, and specifies a provider capable of providing the determined experience as the experience provider.

12. The information processing device according to claim 1, wherein
the provider specification unit determines the experience according to an attribute of the user's place of stay, and specifies a provider capable of providing the determined experience as the experience provider.

13. The information processing device according to claim 1, wherein
the transmission unit transmits experience information data including the information on the experience that is allowed to be provided by the experience provider.

14. The information processing device according to claim 1, wherein
the transmission unit transmits a signal causing the user to select approval or denial with respect to the experience extracted by the provider specification unit.

15. The information processing device according to claim 1, further comprising
a vehicle dispatch unit configured to dispatch a vehicle,
wherein the transmission unit transmits a signal causing the user to select approval or denial with respect to the experience extracted by the provider specification unit, and
the vehicle dispatch unit dispatches the vehicle that moves to the user's place of stay to the user, in response to reception of a signal indicating approval of the experience.

16. An information processing method for processing information about experiences provided to users on a server, the method comprising:
generating movement plan data indicating a user's movement plan;
extracting, when stay time at user's place of stay included in the movement plan is equal to or longer than a predetermined time, an experience different from an original experience at the user's place, and specifying an experience provider capable of moving to the user's place of stay and providing the user with the experience;
calculating the stay time when the stay time becomes longer due to the user having a different experience, and
transmitting, to the user, experience information data including information on the experience that the experience provider can provide and data of a movement plan including information of the calculated stay time.
